(19) United States
(12) Patent Application Publication
(10) Pub. No.: US 2019/0377340 A1
(43) Pub. Date: Dec. 12, 2019

(54) METHOD FOR PILOTING AN AUTONOMOUS MOTOR VEHICLE

(71) Applicant: Valeo Schalter und Sensoren GmbH, Bietigheim-Bissingen (DE)

(72) Inventors: Samia Ahiad, Bietigheim-Bissingen (DE); Ronan Sy, Bietigheim-Bissingen (DE)

(73) Assignee: Valeo Schalter und Sensoren GmbH, Bietigheim-Bissingen (DE)

(21) Appl. No.: 16/477,402

(22) PCT Filed: Jan. 9, 2018
(86) PCT No.: PCT/EP2018/050434

§ 371 Date: Jul. 11, 2019

(30) Foreign Application Priority Data
Jan. 12, 2017 (FR) 1750284

(51) Int. Cl. G05D 1/00; G06K 9/00; B60W 50/08

(52) U.S. Cl. CPC G05D 1/0061; G06K 9/00791; B60W 2050/0072; G05D 1/0088; B60W 50/08; G06K 9/00805

(57) ABSTRACT

The invention relates to a method for piloting means (13, 14, 15) for driving a motor vehicle (10) according to either of two driving modes, i.e.: —a manual driving mode, wherein the driving means are controlled manually, by the motor vehicle driver (20), and —an autonomous driving mode, wherein the driving means are controlled automatically, by a calculation unit (12) of the motor vehicle. According to the invention, when the autonomous driving mode is exited, the following steps are provided: —acquiring at least one image of the surrounding area in from of the motor vehicle, —calculating a coefficient of visibility of at least a portion of the surrounding area in the image acquired, and c) selecting, depending on said coefficient of visibility, a way to exit the autonomous driving mode, from at least two separate exiting ways.

### TECHNICAL HELD TO WHICH THE INVENTION RELATES

The present invention generally relates to aids for driving motor vehicles.

It relates more particularly to a method for controlling means of driving a motor vehicle, said driving means being able to be controlled according to one or other of at least two driving modes, namely:
a manual driving mode in which the driving means are controlled manually, by the driver of the motor vehicle, and
an autonomous driving mode in which the driving means are controlled automatically, by a computation unit of the motor vehicle.

### TECHNOLOGICAL BACKGROUND

A constant concern during the design of motor vehicles is to increase their safety.

Initially, for this purpose systems have been developed making it possible to assist the driver in the driving of his vehicle. It is for example a matter of obstacle detection systems, making it possible to initiate an emergency braking when the driver is not aware of the danger.

It is now sought to develop systems making it possible to drive the vehicle in autonomous mode, that is to say without human intervention. The objective is notably to allow the driver of the vehicle to carry out another activity (reading, telephone . . . ) whilst the vehicle is moving autonomously.

These systems are operated using vehicle environment recognition software, which is based on information coming from various sensors (camera, RADAR sensor, . . . ).

There are situations in which the environment recognition is not considered sufficiently satisfactory to allow the vehicle to move autonomously in traffic.

In these situations, the commonly used solution consists of requesting the driver to resume control of the vehicle within a very short time.

The disadvantage of this solution is that the driver does not then immediately perceive the environment around the vehicle very well. There is therefore a risk that the driver is not aware of a danger and that he does not then react correctly.

### SUBJECT OF THE INVENTION

In order to overcome the abovementioned disadvantage of the prior art, the present invention proposes taking account of the level of visibility of the environment in order to determine if the driver will or will not be capable of perceiving the environment and if he will therefore be capable of resuming control of the vehicle in total safety.

More particularly, according to the invention there is proposed a control method such as defined in the introduction, in which, on exiting the autonomous driving mode, the following steps are provided:

a) acquisition of at least one item of data representing the environment in front of the motor vehicle,

b) computation of a coefficient of visibility of at least a portion of the environment on the basis of the acquired item of data, and

c) selection, as a function of said coefficient of visibility, of a way of exiting from the autonomous driving mode, from among at least two separate exiting ways.

Thus, the invention proposes taking account of the visibility of the environment in order to select one or the other of at least two ways of exiting the autonomous driving mode.

By way of example, if, in step a), the acquired item of data is an image seen by a camera, when the level of visibility is good over the whole of the acquired image, it is possible to switch directly into the manual driving mode, previously warning the driver that he must resume control of the vehicle.

On the other hand, when the level of visibility is low over at least a portion of the acquired image, it is possible to delay the return to the manual driving mode, previously signaling to the driver the existence of a barely visible danger. It is also possible to prohibit this return to the manual driving mode, by switching instead to a degraded driving mode (at low speed, . . . ).

Other advantageous and non-limiting features of the control method according to the invention are as follows:
one way of exiting consists of switching into the manual driving mode within a predetermined short time and another way of exiting consists of switching into a degraded driving mode for a time at least longer than said predetermined short time;
the degraded driving mode consists, for the computation unit, of controlling the driving means in such a way that the motor vehicle brakes or moves at a slow speed and/or in such a way that an alarm emits a signal warning the driver of a potential danger and/or in such a way that the computation unit switches into manual driving mode after a time strictly longer than said predetermined time;
between the steps b) and c), there is provided a step of evaluation of a level of risk which is relative to the capability of the driver to be aware of a potential danger, as a function of said coefficient of visibility and, in step c), the way of exiting is selected as a function of at least the evaluated level of risk;
there is provided a step of detection of the position, of the speed and of the direction of obstacles, and said level of risk is evaluated also as a function of the speed and of the direction of each detected obstacle;
there is provided a step of detection of the direction in which the driver is looking and said level of risk is evaluated as a function also of the direction in which the driver is looking;
said item of data is an image acquired by an image sensor oriented toward the front of the motor vehicle;
in step b), the coefficient of visibility is computed taking account of an overall coefficient characterizing the average visibility of the environment over the whole of the acquired image;
in step b), the coefficient of visibility is computed taking account of at least a local coefficient, characterizing the visibility of a determined portion of the environment on the acquired image;
said specified portion of the environment is an obstacle or a road infrastructure; and
the exiting from the autonomous driving mode is commanded when the computation unit receives an instruction from an input means available to the driver, or when it establishes an impossibility of driving in autonomous mode taking account of signals received from environment sensors.

### DETAILED DESCRIPTION OF AN EXAMPLE OF EMBODIMENT

The following description given with reference to the appended drawings, given as non-limiting examples, will give a good understanding of what the invention consists of and of how it can be embodied.

In the appended drawings:

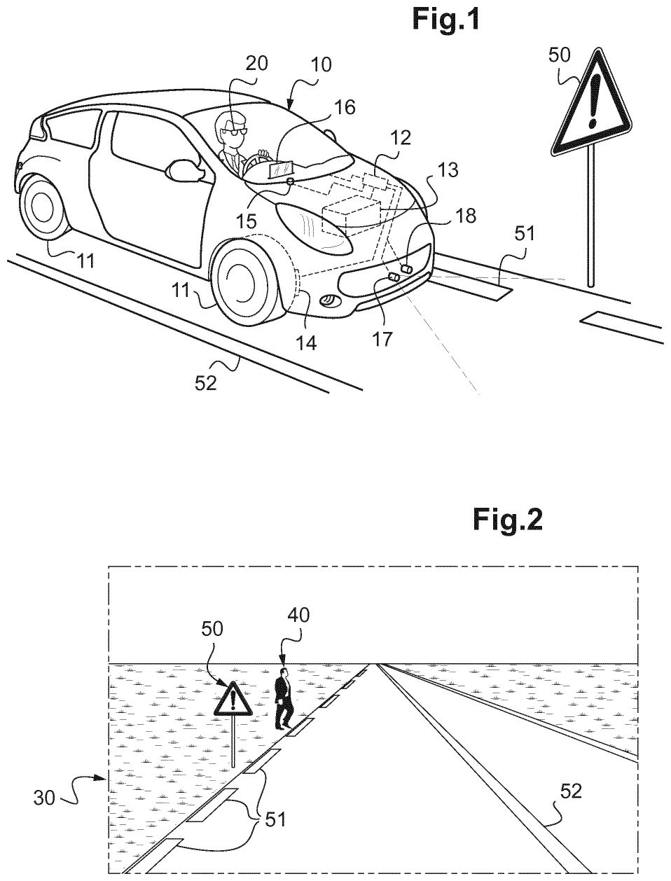

FIG. 1 is a diagrammatic view in perspective of a motor vehicle driving on a road; and

FIG. 2 is a representation of an image acquired by an image sensor equipping the motor vehicle shown in FIG. 1.

In FIG. 1, there is shown a motor vehicle 10 which appears here in the form of a car having four wheels 11. As a variant, it could be a motor vehicle having three wheels, or more wheels.

Conventionally, this motor vehicle 10 comprises a chassis which notably supports a power train 13 (namely an engine and means of transmission of the torque produced by the engine to the drive wheels), a steering system 15 (namely a steering wheel fixed to a steering column coupled to the steerable wheels of the vehicle), a braking system 14 (namely a brake pedal connected to brake calipers), bodywork elements and passenger compartment elements.

It will firstly be noted that the power train 13, the steering system 15 and the braking system 14 form what it is appropriate to call “driving means”, that is to say means making it possible to drive the vehicle at the desired speed, in the desired direction.

The motor vehicle 10 also comprises an electronic control unit (or ECU, standing for “Electronic Control Unit” in English), referred to here as a computer 12.

This computer 12 comprises a processor and a storage unit, for example a rewritable non-volatile memory or a hard disk.

The storage unit notably comprises computer programs comprising instructions whose execution by the processor allows the implementation by the computer of the method described below.

For the implementation of this method, the computer 12 is connected to different hardware items of the motor vehicle 10.

Among these hardware items, the motor vehicle 10 comprises at least one image sensor 17. In this case it also comprises a head-up display 16 and at least one distance detector, for example a RADAR detector 18.

In this case the image sensor is formed by a camera 17 which is oriented towards the front, in such a way that it can acquire images of a portion of the road which is located in front of the vehicle.

This camera 17 is shown here as being fixed in the front bumper of the vehicle. As a variant, it could be situated otherwise, for example behind the windscreen of the vehicle.

This camera 17 is designed to acquire images of a portion of the road located in front of the vehicle and to communicate these images (or data corning from these images) to the computer 12 of the vehicle.

Thanks to the information collected by the camera 17 and by the RADAR detector 18, the computer 12 is capable of assessing the environment located in front of the vehicle.

The computer 12 therefore hosts software making it possible to drive the driving members 13, 14, 15 autonomously, without human intervention. The motor vehicle 10 is then said to be “autonomous”. As various embodiments of this software are already known by those skilled in the art, it will not be descried in detail here.

In practice, the computer 12 is more precisely connected to actuators of the driving means 13, 14, 15, for example to a steering motor making it possible to control the steering system 15, to a servomotor making it possible to control the braking system 14 and to a servomotor making it possible to control the power train 13.

The computer 12 is therefore programmed in such a way as to be able to switch between different driving modes, among which there are at least:
an autonomous driving mode in which the driving means 13, 14, 15 are controlled automatically, exclusively by the computer 12, and
a manual driving mode in which the driving means 13, 14, 15 are controlled manually, by the driver 20 of the motor vehicle 10.

It will be noted that in this manual driving mode, the control members of the driving means 13, 14, 14 will eventually be able to be controlled by the computer 12 in such a way as to assist the driver in driving the vehicle (in order to apply emergency braking, or to limit the speed of the vehicle . . . ). Dans this case, the computer 12 will control these control members taking account of the forces applied by the driver on the steering wheel and on the pedals of the vehicle.

In the continuation of this description, it will be considered that the computer 12 is programmed in such a way as to also be able to switch into a third driving mode, namely a degraded driving mode.

Several variant embodiments of this degraded driving mode can be envisaged.

In a first variant, the driving means 13, 14, 15 can be controlled automatically, exclusively by the computer 12, in such a way that the vehicle brakes progressively.

In another variant, the driving means 13, 14, 15 can be controlled automatically, exclusively by the computer 12, in such a way that the vehicle brakes and then stabilizes itself at a reduced speed, lower than the speed at which the vehicle would drive in autonomous mode.

In another variant, the driving means 13, 14, 15 can be controlled partly by the computer 12 and partly by the driver, in which case an alarm will emit a signal warning the driver 20 of the potential dangers detected. This alarm will for example be able to be formed by the head up display 16, in which case the signal will be able to be in the form of an image displayed on the head up display 16.

Therefore, the invention is more precisely about the way in which the computer 12 must manage the exit from the autonomous driving mode.

It can in fact happen that the driver wishes to resume control of the vehicle, in which case he can for example press a button for deactivation of the autonomous driving mode.

It can also happen that, taking account of the information received from the camera 17 and from the RADAR sensor 18, the computer 12 judges that it is no longer capable of driving the vehicle autonomously and that it must exit from the autonomous driving mode.

In both of these cases, it is appropriate to ensure, before switching into manual driving mode, that the driver is capable of correctly assessing the environment in order to drive the vehicle without danger.

In order to do this, according to a particularly advantageous feature, the computer 12 implements four consecutive steps, namely:
a step of acquisition of at least one image 30 of the environment in front of the motor vehicle 10,
a step of computation of a coefficient of visibility Cv of at least a portion of the environment on the acquired image 30,
a step of evaluation of a level of risk Nr which is relative to the capability of the driver 20 to be aware of a potential danger, as a function of said coefficient of visibility Cv, and
a step of selection, as a function of said level of risk Nr, of a way of exiting the autonomous driving mode, from among at least two separate ways of exiting.

In this case, by way of example, a first way of exiting consists of switching into manual driving mode within a predetermined short time. A second way of exiting consists of switching into manual driving mode within a longer time. A third way of exiting consists of switching into a degraded driving mode.

The abovementioned four steps can now be described in greater detail.

During the first step, the computer 12 stores the successive images acquired by the camera 18.

One of these images 30 is shown in FIG. 2.

In it, there is observed not only the road followed by the vehicle, but also the infrastructures de the road and possible obstacles.

Among the infrastructures, there can be seen here a road sign 50, a discontinuous line 51 on the left-hand side of the road, and a continuous central line 52.

Among the obstacles, can be noted, in addition to the road sign 50, a pedestrian 40 who is walking and who is about to cross the road. The speed and the direction of each obstacle can be computed as a function of the position of that obstacle on the successive acquired images.

During the second step, the computer 12 computes the coefficient of visibility Cv on the last image acquired.

This coefficient of visibility could be an overall coefficient quantifying the average luminosity over the whole of the image, which would for example make it possible to distinguish a situation in which the weather is fine and where the luminosity is good, from a situation where it is dark (nighttime, cloudy, . . . ) and where the luminosity is low.

As a variant, this coefficient of visibility could be a local coefficient quantifying the luminosity of a portion of the image, for example the luminosity of an obstacle.

In this case, and in a preferred manner, the coefficient of visibility Cv is computed as a function of:
an overall coefficient Cv1 characterizing the visibility of the environment over the whole of he acquired image 30, and
several local coefficients Cv2ᵢ characterizing the visibility of determined different portions of the acquired image 30.

Hesse determined portions of the image 30 can for example be the infrastructures of the road and some of the obstacles (the latter, taking account of their position, speed and direction, risk intersecting the trajectory of the vehicle).

The computation of the overall coefficient Cv1 is well known to those skilled in the art. It is for example described in the document EP2747027. It will not therefore be described in greater detail here.

The computation of the local coefficients Cv2 is also known to those skilled in the art. It is for example described in the document published in 2005 by Messrs. Nicolas Hautière, Raphaėl Labayrade and Didier Aubert, which is entitled “Detection of Visibility condition through use of onboard cameras” (Université Jean Monnet—Saint Etienne).

The computation of the coefficient of visibility Cv in his case takes account of these different coefficients. The significance assigned to the overall coefficient Cv1 and to the local coefficients Cv2ᵢ in the computation of the coefficient of visibility Cv will be determined case by case, notably as a function of characteristics of the optics of the camera 18 and of the sensitivity of the optical sensor of that camera.

During the third step, the level of risk Nr is evaluated as a function of this coefficient of visibility Cv.

The higher the coefficient of visibility Cv is (that is to say the more visible the environment is), the lower is the evaluated level of risk Nr.

On the contrary, the lower the coefficient of visibility Cv is (that is to say the less visible the environment is), the higher is the evaluated level of risk Nr.

It is possible to compute several levels of risk Nr, each one associated with an object on the road, and then to consider the highest level of risk Nr in the continuation of the method.

The level of risk Nr associated with an object on the road is evaluated as a function of the estimated reaction time of the driver. The latter depends on the coefficient of visibility of the object in question. The higher the coefficient of visibility is, the shorter is the reaction time of the driver and therefore the lower is the danger.

The relationship between the coefficient of visibility and the reaction time can be estimated experimentally over a representative sample of people. By way of example, it can be considered that the reaction time varies between 1 second and 0.5 second as the coefficient of visibility rises, at first reducing very quickly and then stabilizing about the value 0.5 second (hyperbolic variation).

A simple and non-exhaustive example consists of considering any object which is likely to intercept the trajectory of the vehicle and which is associated with a reaction time longer than 0.5 second as being dangerous (the objects not bringing these two criteria together being considered as not dangerous).

Thus, the level of risk Nr is evaluated as a function not only of the coefficient of visibility Cv, but also as a function of other data such as the position, the speed and the direction of each obstacle 40 detected.

It is for example also possible to determine the direction in which the driver is looking and to computer the level of risk Nr as a function of that direction. The level of risk will then be higher when the driver is not looking at the road or when he is looking in a direction opposite to that of the detected obstacles.

Finally, during the fourth step, the computer 12 compares the level of risk Nr with a predetermined threshold.

If that level of risk is less than that predetermined threshold, the computer 12 automatically switches into manual driving mode, after a short time allowing the driver to react and to regain control of the steering.

On the contrary, if the level of risk is higher than this predetermined threshold, the computer can switch into one of the degraded driving modes described above.

As a variant, notably in the case where the driver has required exiting from the autonomous mode, the computer 12 can choose to remain in autonomous driving mode for a prolonged time (longer than the aforesaid “short time”). It can remain there:
either as long as the computed level of risk remains higher than the threshold,
or for a predetermined time longer than the aforesaid “short time”.

The present invention is in no way limited to the embodiment described and shown, but those skilled in the art will know how to apply any variant to it whilst complying with the invention.

Thus, it would be possible not to use a step of computation of a level of risk but, on the contrary, to determine directly which driving mode the computer must switch into as a function of the coefficient of visibility Cv.

According to another variant of the invention, it will be possible to use (instead and in place of the camera) another type of sensor, provided that the latter can provide data which can be used for determining coefficients de visibility and levels of risk. By way of example, this sensor could be a three-dimensional scanner (better known by its English name “Laser Scanner”).

1. A method for controlling means of driving a motor vehicle, said driving means being able to be controlled according to one or other of at least two driving modes, comprising:
a manual driving mode in which the driving means are controlled manually, by the driver of the motor vehicle, and
an autonomous driving mode in which the driving means are controlled automatically, by a computation unit of the motor vehicle,
the method comprising, on exiting the autonomous driving mode:
a) acquisition of at least one item of data representing the environment in front of the motor vehicle;
b) computation of a coefficient of visibility of at least a portion of the environment on the basis of the acquired item of data; and
c) selection, as a function of said coefficient of visibility, of a way of exiting from the autonomous driving mode, from among at least two separate exiting ways.

2. The control method as claimed in claim 1, wherein one of the two ways of exiting consists of switching into the manual driving mode after a predetermined time and another way of the two ways of exiting consists of switching into a degraded driving mode.

3. The control method as claimed in claim 2, wherein the degraded driving mode consists, for the computation unit, of controlling the driving means so that: the motor vehicle brakes or moves at a slow speed, so that an alarm emits a signal warning the driver of a potential danger, or so that the computation unit switches into manual driving mode after a time strictly longer than said predetermined time.

4. The control method as claimed in claim 1, wherein:
further comprising, between b) and c), evaluation of a level of risk which is relative to the capability of the driver to be aware of a potential danger, as a function of said coefficient of visibility and,
in c), the way of exiting is selected as a function of at least the evaluated level of risk.

5. The control method as claimed in claim 4, further comprising: detection of obstacles, and of determination of the position, of the speed and of the direction of each detected obstacle, wherein said level of risk is evaluated also as a function of the position, of the speed and of the direction of each detected obstacle.

6. The control method as claimed in claim 4, further comprising: detection of the direction in which the driver is looking and wherein said level of risk is evaluated as a function also of the direction in which the driver is looking.

7. The control method as claimed in claim 1, wherein said item of data is an image acquired by an image sensor oriented toward the front of the motor vehicle.

8. The control method as claimed in claim 7, wherein, in b), the coefficient of visibility is computed taking account of an overall coefficient characterizing the average visibility of the environment over the whole of the acquired image.

9. The control method as claimed in claim 7, wherein in b), the coefficient of visibility is computed taking account of at least a local coefficient, characterizing the visibility of a determined portion of the environment on the acquired image.

10. The control method as claimed in claim 9, wherein said determined portion of the environment is an obstacle or a read infrastructure.

11. The control method as claimed in claim 1, wherein the exiling from the autonomous driving mode is commanded when the computation unit receives an instruction from an input means available to the driver, or when the computation unit establishes an impossibility of continuing driving in autonomous mode taking account of signals received from environment sensors.
